(19) United States
(12) Patent Application Publication
(10) Pub. No.: US 2023/0033495 A1
(43) Pub. Date: Feb. 2, 2023

(54) EVALUATION METHOD FOR TRAINING DATA, PROGRAM, GENERATION METHOD FOR TRAINING DATA, GENERATION METHOD FOR TRAINED MODEL, AND EVALUATION SYSTEM FOR TRAINING DATA

(71) Applicant: Panasonic Intellectual Property Management co., Ltd., Osaka (JP)

(72) Inventors: TAICHI SATO, Kyoto (JP); HIDETO MOTOMURA, Kyoto (JP); RYOSUKE GOTO, Osaka (JP)

(21) Appl. No.: 17/756,538

(22) PCT Filed: Dec. 17, 2020
(86) PCT No.: PCT/JP2020/047188

§ 371 Date: May 26, 2022

(30) Foreign Application Priority Data
Dec. 24, 2019 (JP) 2019-233422

(51) Int. Cl. G06V 10/776

(52) U.S. Cl. CPC G06V 10/776

(57) ABSTRACT

Provided is an evaluation method for learning data that facilitates generation of learning data that can contribute to the improvement of the recognition rate of a model. An evaluation method for learning data includes a first evaluation step and a second evaluation step. The first evaluation step is a step of evaluating the performance of learned model machine-learned by using learning data generated by the data extension processing. The second evaluation step is a step of evaluating a parameter on the basis of the evaluation obtained in the first evaluation step and the possible range of the parameter of the data extension processing.

### TECHNICAL FIELD

The present disclosure generally relates to an evaluation method for learning data, a program, a generation method for learning data, a generation method for learned model, and an evaluation system for learning data More specifically, the present disclosure relates to an evaluation method for learning data used for machine learning of a model, a program for the method, a generation method for learning data, a generation method for learned model, and an evaluation system for learning data

### BACKGROUND ART

NPL 1 discloses a data extension method for improving the accuracy of a modern image classifier.

### CITATION LIST

### Non-Patent Literature

NPL 1: Ekin D. Cubuk et al., “AutoAugment: Learning Augmentation Strategies from Data”, arXiv:1805.09501v3[cs.CV], 11 Apr. 2019

### SUMMARY OF THE INVENTION

An object of the present disclosure is to provide an evaluation method for learning data that allows easy generation of learning data that can contribute to the improvement of a model recognition rate, a program, a generation method for learning data, a generation method for learned model, and an evaluation system for learning data.

An evaluation method for learning data according to one aspect of the present disclosure includes a first evaluation step and a second evaluation step. The first evaluation step is a step of evaluating the performance of a learned model machine-learned by using learning data generated by the data extension processing. The second evaluation step is a step of evaluating a parameter on the basis of the evaluation obtained in the first evaluation step and the possible range of the parameter of the data extension processing.

A program according to another aspect of the present disclosure causes one or more processors to execute the evaluation method for learning data described above.

A generation method for learning data according to another aspect of the present disclosure includes a first evaluation step, a second evaluation step, an update step, and a data generation step. The first evaluation step is a step of evaluating the performance of a learned model machine-learned by using learning data generated by the data extension processing. The second evaluation step is a step of evaluating a parameter on the basis of the evaluation obtained in the first evaluation step and the possible range of the parameter of the data extension processing. The update step is a step of updating a parameter on the basis of the evaluation obtained in the second evaluation step. The data generation step is a step of generating learning data by data extension processing based on the parameter updated in the update step.

A generation method for a learned model according to another aspect of the present disclosure includes a first evaluation step, a second evaluation step, an update step, a data generation step, and a model generation step. The first evaluation step is a step of evaluating the performance of a learned model machine-learned by using learning data generated by the data extension processing. The second evaluation step is a step of evaluating a parameter on the basis of the evaluation obtained in the first evaluation step and the possible range of the parameter of the data extension processing. The update step is a step of updating a parameter on the basis of the evaluation obtained in the second evaluation step. The data generation step is a step of generating learning data by data extension processing based on the parameter updated in the update step. The model generation step is a step of generating a learned model by performing machine learning using learning data generated in the data generation step.

An evaluation system for learning data according to another aspect of the present disclosure includes a first evaluator and a second evaluator. The first evaluator evaluates the performance of a learned model machine-learned by using learning data generated by the data extension processing. The second evaluator evaluates the parameter on the basis of the evaluation obtained by the first evaluator and the possible range of the parameter of the data extension processing.

The present disclosure has an advantage that it is easy to generate learning data that can contribute to the improvement of a model recognition rate.

### BRIEF DESCRIPTION OF THE DRAWINGS

FIG. 1 is a block diagram illustrating a model generation system including an evaluation system for learning data according to an exemplary embodiment of the present disclosure.

FIG. 2 is a schematic diagram of an example of a recognition target of a learned model in the model generation system.

FIG. 3A is an explanatory diagram of an example of a defective product as the recognition target.

FIG. 3B is an explanatory diagram of an example of a defective product as the recognition target.

FIG. 3C is an explanatory diagram of an example of a defective product as the recognition target.

FIG. 4 is a schematic diagram illustrating an example of image data included in original learning data in the model generation system.

FIG. 5 is a schematic diagram illustrating an example of image data included in learning data generated on the basis of original learning data in the model generation system.

FIG. 6A is a schematic diagram illustrating an example of image data obtained by imaging a non-defective bead in the model generation system.

FIG. 6B is a schematic diagram illustrating an example of image data included in learning data generated by adding an additional image to the image data illustrated in FIG. 6A.

FIG. 7 is a flowchart illustrating an operation of the model generation system.

### DESCRIPTION OF EMBODIMENT

### Outline

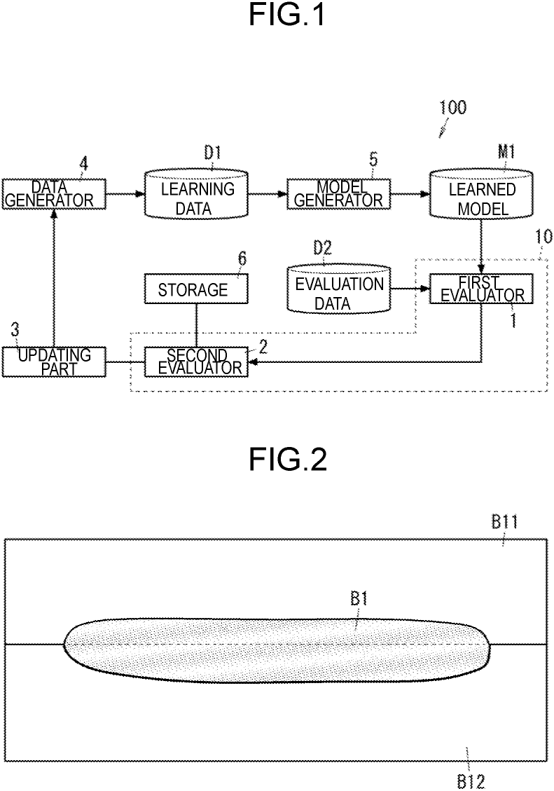

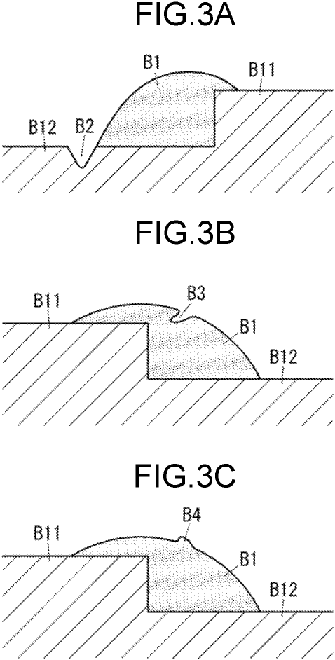

A method for evaluating learning data according to the present exemplary embodiment is a method for evaluating learning data used for machine learning of a model. The “model” in the present disclosure is a program that, when receiving data regarding a recognition target, estimates the state of the recognition target and outputs an estimation result. Hereinafter, the model on which machine learning using learning data is completed will be referred to as a “learned model”. In addition, the “learned data ” referred to in the present disclosure is a data set obtained by combining input information (in the present exemplary embodiment, image data) input to a model and a label given to the input information, and is so-called teacher data. That is, in the present exemplary embodiment, the learned model is a model on which machine learning by supervised learning is completed. In the present exemplary embodiment, the evaluation method for learning data is implemented by evaluation system 10 of learning data (to be also simply referred to as “evaluation system 10” hereinafter) illustrated in FIG. 1. FIG. 1 is a block diagram illustrating model generation system 100 including evaluation system 10 for learning data according to an exemplary embodiment of the present disclosure. FIG. 2 is a schematic diagram of an example of a recognition target of a learned model in model generation system 100 illustrated in FIG. 1.

In the present exemplary embodiment, as illustrated in FIG. 2, the recognition target is bead B1 formed at a welded portion when two or more members (first plate B11 and second plate B12 in this case) are welded. When image data including bead B1 is input, learned model M1 (see FIG. 1) estimates the state of bead B1 and outputs the estimation result. More specifically, learned model M1 outputs, as the estimation result, information indicating whether bead B1 is a non-defective product or a defective product, or the type of defective product when bead B1 is a defective product. That is, learned model M1 is used for welding appearance inspection for inspecting whether or not bead B1 is a non-defective product, in other words, whether or not welding has been correctly performed.

Whether or not bead B1 is a non-defective product is determined by, for example, whether or not the length of bead B1, the height of bead B1, the rising angle of bead B1, the throat thickness of bead B1, the excess weld metal of bead B1, and the position deviation of welded portion of bead B1 (including the deviation of the starting end of bead B1) fall within allowable ranges. For example, when even one of the conditions listed above does not fall within the allowable range, it is determined that bead B1 is a defective product. FIGS. 3A to 3C each are an explanatory diagram illustrating an example of defective bead B1 as a recognition target. FIGS. 3A to 3C are cross-sectional views including bead B 1. Whether bead B 1 is a non-defective product is determined based on, for example, the presence or absence of undercut B2 (see FIG. 3A) of bead B1, the presence or absence of pit B3 (see FIG. 3B) of bead B1, the presence or absence of spatter B4 (see FIG. 3C) of bead B1, and the presence or absence of a projection of bead B1. For example, when any one of the defective portions listed above occurs, it is determined that bead B1 is a defective product.

In this case, in order to perform machine learning of a model, it is necessary to prepare a large number of pieces of image data including a defective product as a recognition target as learning data D1 (see FIG. 1). However, in a case where the frequency of occurrence of defective products as recognition targets is low, learning data D1 necessary for generating learned model M1 having a high recognition rate tends to be insufficient. Accordingly, it is conceivable to perform machine learning of the model by increasing the number of pieces of learning data D1 by executing data extension (Data Augmentation) processing on learning data D1 obtained by actually imaging bead B1 using an imaging device (the learning data obtained by actually imaging bead B1 using the imaging device is also referred to as “original learning data” hereinafter). The “data extension processing” mentioned here refers to the process of artificially padding learning data by adding a process such as translation, enlargement/reduction, rotation, inversion, or noise addition to learning data D1.

However, it is not sufficient to simply perform data extension processing on learning data D1 as original learning data. In some cases, when machine learning is performed using newly generated learning data D1, the recognition rate of learned model M1 may decrease. That is, it is desirable to perform data extension that can generate learning data D1 appropriate for machine learning of the model, which can contribute to the improvement of the recognition rate of learned model M1.

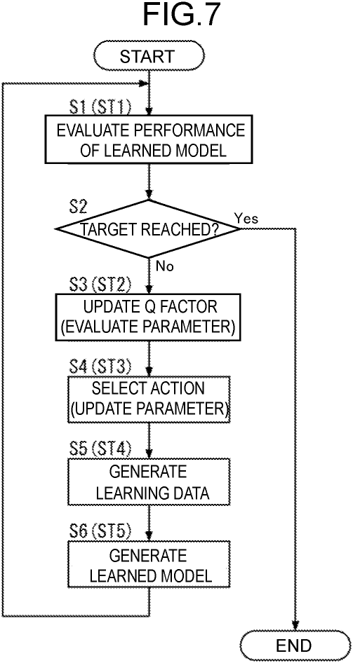

Accordingly, in the present exemplary embodiment, evaluating learning data D1 by the evaluation method for learning data D1 makes it easy to generate learning data D1 appropriate for machine learning of the model by the data extension processing. FIG. 7 is a flowchart illustrating an operation of model generation system 100. The evaluation method for learning data D1 according to the present exemplary embodiment includes first evaluation step ST1 (see FIG. 7) and second evaluation step ST2 (see FIG. 7).

First evaluation step ST1 is a step of evaluating the performance of learned model M1 machine-learned by using learning data D1 generated by the data extension processing. The “data extension processing” referred to in the present disclosure can include the processing of newly generating learning data D1 on the basis of the parameters of the data extension processing without using any original learning data, in addition to the processing executed on the original learning data. For example, the data extension processing may include the processing of generating image data including non-defective bead B1 or image data including defective bead B1 without using learning data D1 as original learning data by a computer graphics (CG) technology.

Second evaluation step ST2 is a step of evaluating the parameters (of the data extension processing) on the basis of the evaluation in first evaluation step ST1 and the possible range of the parameters of the data extension processing. A “parameter of the data extension processing” in the present disclosure refers to the degree of data extension processing such as translation, enlargement/reduction, rotation, inversion, or noise addition, which is executed on part or all of the processing target data. For example, in a case where the image data of defective bead B1 having a projection on the surface is set as processing target data, the parameters of the data extension processing may include the movement amount of the projection, the size of the projection, and the rotation amount of the projection.

In this case, for the parameters of the data extension processing, a changeable range is set for each type of processing. For example, when the parameter is the movement amount for a projection, the movement amount can be changed in the range of 0 mm to several tens mm. Note that a parameter of the data extension processing may be one value, that is, a predetermined one value. In addition, a parameter of the data extension processing is determined between the upper limit value and the lower limit value in predetermined processing. When data extension is performed, the parameters may be randomly determined within ranges of upper limit values and lower limit values. In addition, a parameter of the data extension processing may be a statistical value such as an average or a variance taken by a value such as a movement amount when data extension is performed.

As described above, in the present exemplary embodiment, the performance of learned model M1 is evaluated, and the parameters of the data extension processing are evaluated on the basis of the evaluation. Therefore, in the present exemplary embodiment, it is possible to indirectly evaluate whether or not learning data D1 generated by the data extension processing is appropriate data for the generation of learned model M1. As a result, in the present exemplary embodiment, there is an advantage that it is easy to generate learning data D1 that can contribute to the improvement of the model recognition rate by updating the parameters of the subsequent data extension processing based on the evaluation of the parameters of the data extension processing.

### Details

Evaluation system 10 for implementing the evaluation method for learning data according to the present exemplary embodiment and model generation system 100 for generating learned model M1 using evaluation system 10 will be described in detail below with reference to FIG. 1. As illustrated in FIG. 1, model generation system 100 includes evaluation system 10, updating part 3, data generator 4, model generator 5, and storage 6. Evaluation system 10 includes first evaluator 1 and second evaluator 2.

In the present exemplary embodiment, as described above, model generation system 100 (including evaluation system 10) mainly includes a computer system having one or more processors and memories except for storage 6. Accordingly, one or more processors execute programs recorded in the memory to function as first evaluator 1, second evaluator 2, updating part 3, data generator 4, and model generator 5. The programs may be recorded in advance in the memory, may be provided through a telecommunication line such as the Internet, or may be provided by being recorded in a non-transitory recording medium such as a memory card.

Data generator 4 generates learning data D1 by data extension processing based on the parameters updated by updating part 3. The “generation of learning data” referred to in the present disclosure can include generating new learning data D1 by updating existing learning data D1 in addition to generating new learning data D1 separately from existing learning data D1. In addition, at the initial time before updating part 3 updates the parameters, data generator 4 generates learning data D1 by data extension processing based on preset initial parameters.

In the present exemplary embodiment, there are a plurality of types of parameters of data extension processing. A changeable range is set for each of the plurality of types of parameters. In this case, for example, it is assumed that data generator 4 executes data extension processing on arbitrary original learning data. In this case, data generator 4 sequentially executes data extension processing on the original learning data while changing the processing amount of one or more parameters among the plurality of types of parameters within a changeable range. As a result, data generator 4 can generate a large number of learning data D1 on the basis of one original learning data.

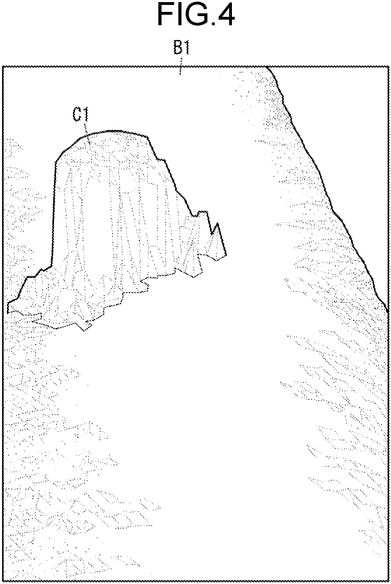

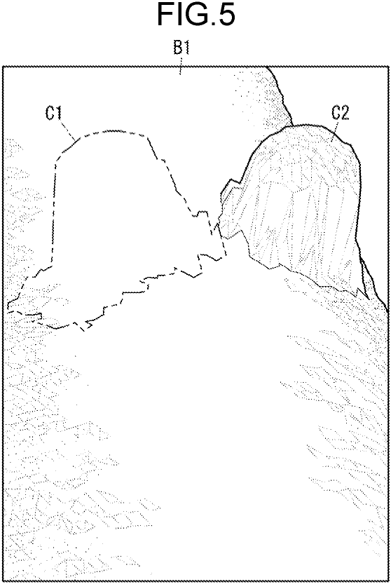

FIG. 4 is a schematic diagram illustrating an example of image data included in original learning data in model generation system 100. FIG. 5 is a schematic diagram illustrating an example of image data included in learning data generated on the basis of original learning data in model generation system 100. For example, it is assumed that there is original learning data including image data as illustrated in FIG. 4. This image data is the data of defective bead B1 with projection C1 protruding from the surface of bead B1. Accordingly, the label of this original learning data is “defective product: with projection”. Data generator 4 can generate image data as illustrated in FIG. 5 by executing, for example, the data extension processing of translating projection C1 with respect to the image data. In the example illustrated in FIG. 5, projection C1 before the execution of the data extension process is indicated by the two-dot chain line. In the example illustrated in FIG. 5, projection C2 after the execution of the data extension process is indicated by “C2”.

Data generator 4 generates learning data D1 by assigning “defective product: with projection”, which is the same label as the original learning data, to the image data. In this case, data generator 4 generates a large number of learning data D1 respectively having projections C1 at different positions by changing the movement amount of projection C1 translated in stages within a changeable range.

In the present exemplary embodiment, data generator 4 generates learning data D1 including the image data of defective bead B1 by adding an image (for example, an image of a projection or the like of bead B 1) representing a characteristic of the defective product to the original learning data including the image data of non-defective bead B1.That is, learning data D1 is generated by adding additional image D11 based on the parameters (of data extension processing) to the image data including the recognition target (bead B1 in this case) of learned model M1.

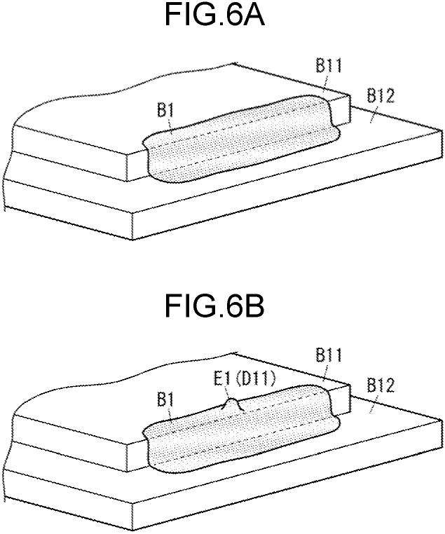

FIG. 6A is a schematic diagram illustrating an example of image data obtained by imaging non-defective bead B1 in model generation system 100. FIG. 6B is a schematic diagram illustrating an example of image data included in learning data generated by adding an additional image to the image data illustrated in FIG. 6A. For example, it is assumed that there is original learning data including image data as illustrated in FIG. 6A. This image data is the data of non-defective bead B1. Accordingly, the label of this original learning data is “non-defective product”. Data generator 4 can generate image data as illustrated in FIG. 6B by executing the data extension processing of adding projection E1 protruding from the surface of bead B1 to the image data, for example, as additional image D11. Data generator 4 generates learning data D1 by assigning “projection (defective product)”, which is a label different from that of the original learning data, to the image data. Note that, in a case where semantic segmentation for recognizing the position and type of a defect is to be learned, the label for learning data D1 is set to the range of E1(D11) and the position of “projection” for each defect type.

Model generator 5 generates learned model M1 by performing machine learning using learning data D1 generated by data generator 4. The “generation of learned model” referred to in the present disclosure can include generating new learned model M1 by updating existing learned model M1 in addition to generating new learned model M1 separately from existing learned model M1. In the present exemplary embodiment, model generator 5 generates learned model M1 by the former method.

Model generator 5 generates, as learned model M1, a model using a neural network, a model by deep learning using a multilayer neural network, or the like, in addition to a linear model such as a support vector machine (SVM), for example. In the present exemplary embodiment, model generator 5 generates a model using a neural network as learned model M1. The neural network may include, for example, a convolutional neural network (CNN) or a bayesian neural network (BNN).

Storage 6 includes one or more storage devices. Examples of the storage device are a random access memory (RAM) and an electrically erasable programmable read only memory (EEPROM). Storage 6 stores a Q table to be described later.

First evaluator 1 evaluates the performance of learned model M1 machine-learned by using learning data D1 generated by the data extension processing. That is, first evaluator 1 is an execution subject of first evaluation step ST1. First evaluator 1 evaluates the performance of learned model M1 based on the output of learned model M1 obtained by inputting evaluation data D2 to learned model M1.

Evaluation data D2 is a data set obtained by combining input information (in the present exemplary embodiment, image data) input to learned model M1 and a label given to the input information. In the present exemplary embodiment, evaluation data D2 is, for example, a combination of image data obtained by actually imaging bead B1, such as original learning data, and a label given to the image data. For example, the label is information indicating whether bead B1 included in the image data is a non-defective product or a defective product. In addition, for example, when bead B1 included in the image data is a defective product, the label is information indicating what kind of defect (undercut B2, pit B3, sputter B4, or the like) bead B1 has.

In the present exemplary embodiment, first evaluator 1 sequentially inputs the plurality of pieces of evaluation data D2 to learned model M1 and determines whether or not the estimation result of learned model M1 matches the label of input evaluation data D2. First evaluator 1 outputs the recognition rate (that is, (number of correct answers)/(number of all evaluation data) × 100) of learned model M1 for the plurality of pieces of evaluation data D2 as the evaluation of the performance of learned model M1.

The first evaluation value indicates that, if there is data similar to evaluation data D2 in learning data D1, the recognition rate at the time of estimation concerning the recognition target increases. Accordingly, instead of using the first evaluation as the recognition rate of learned model M1 for the plurality of pieces of evaluation data D2, the similarity between learning data D1 and evaluation data D2 may be used as the first evaluation. The similarity between learning data D1 and evaluation data D2 is a value that increases the recognition rate at the time of estimation concerning the recognition target if there is data similar to evaluation data D2 in learning data D1. That is, in the first evaluation, the higher the similarity between each element constituting evaluation data D2 and learning data D1, the higher the evaluation value. In this case, the similarity between each element constituting evaluation data D2 and learning data D1 is, for example, the similarity between the data, of the data included in learning data D1, which is most similar to evaluation data D2, and evaluation data D2. Evaluation data D2 includes a plurality of pieces of data, and each element is one piece of data constituting evaluation data D2.

A specific example will be described below. It is assumed that learning data D1 includes N + 1 pieces of image data. The N + 1 pieces of image data are referred to as images D1_0,..., D1_N, respectively. Similarly, it is assumed that evaluation data D2 includes M + 1 pieces of image data. The M + 1 pieces of image data are referred to as images D2_0,..., D2_M, respectively. When an image that is the most similar to image D2_0 among learning data D1 is image X, the first evaluation calculates the similarity between image D2_0 and image X as H_0. Similarly, first evaluator 1 calculates H_1,..., H_M and sets H_0+,..., +H_M as the first evaluation. In this case, similarity is calculated by using mean squared error (MSE), structural similarity (SSIM), or the like.

Alternatively, the first evaluation may be evaluation based on the distance between image feature amount vectors constructed by deep learning created by performing learning with a large amount of general object images. By using such a configuration, it is possible to obtain the first evaluation in a shorter time than when learning is performed every time using learning data D1.

The above is an example of a method of evaluating the similarity between learning data D1 and the evaluation data. Other similarity evaluation methods may be used.

Second evaluator 2 evaluates the parameter (of the data extension processing) on the basis of the evaluation obtained by first evaluator 1 and the possible range of the parameter of the data extension processing. In the present exemplary embodiment, second evaluator 2 evaluates the parameters of data extension processing using Q learning, which is a type of reinforcement learning. Second evaluator 2 gives “reward” to the transition from the current state to the next state by the selection of action, assuming that the evaluation obtained by first evaluator 1 (that is, the recognition rate of learned model M1) is “state” and a change in a parameter of data extension processing is “action”. For example, second evaluator 2 gives a reward of “+α” (“α” is a natural number) in a case where the recognition rate of learned model M1 is improved by machine learning after a change in a parameter of data extension processing and gives a reward of “-β” (“β” is a natural number) in a case where the recognition rate of learned model M1 is reduced.

In the present exemplary embodiment, second evaluator 2 evaluates a parameter of data extension processing by updating the state action value (Q factor) of each cell (field) of the Q table illustrated in following Table 1 stored in storage 6. In the example illustrated in Table 1, the Q factors of all the cells in the Q table are initial values (zero).

Table 1

| | y11+ | y11- | y12+ | y12- | y21+ | y21- | y22+ | y22- |
|---|---|---|---|---|---|---|---|---|
| x1 | 0 | 0 | 0 | 0 | 0 | 0 | 0 | 0 |
| x2 | 0 | 0 | 0 | 0 | 0 | 0 | 0 | 0 |
| x3 | 0 | 0 | 0 | 0 | 0 | 0 | 0 | 0 |
| x4 | 0 | 0 | 0 | 0 | 0 | 0 | 0 | 0 |
| x5 | 0 | 0 | 0 | 0 | 0 | 0 | 0 | 0 |

In the example shown in Table 1, “x1” to “x5” each represent a state. More specifically, “x1” represents a state in which the recognition rate of learned model M1 is less than 25%, “x2” represents a state in which the recognition rate of learned model M1 is 25% or more and less than 50%, and “x3” represents a state in which the recognition rate of learned model M1 is 50% or more and less than 75%. In addition, “x4” represents a state in which the recognition rate of learned model M1 is 75% or more and less than 95%, and “x5” represents a state in which the recognition rate of learned model M1 is 95% or more.

In the example illustrated in Table 1, “y11+”, “y11-”, “y12+”, “y12-”, “y21+”, “y21-”, “y22+”, and “y22-” represent actions, respectively. More specifically, “y11+” represents an action of increasing the upper limit value of the first parameter, “y11-” represents an action of decreasing the upper limit value of the first parameter, “y12+” represents an action of increasing the lower limit value of the first parameter, and “y12-” represents an action of decreasing the lower limit value of the first parameter. In this case, the first parameter is the variable range of the diameter dimension of projection C1 protruding from the surface of bead B1. In addition, “y21+” represents an action of increasing the upper limit value of the second parameter, “y21-” represents an action of decreasing the upper limit value of the second parameter, “y22+” represents an action of increasing the lower limit value of the second parameter, and “y22-” represents an action of decreasing the lower limit value of the second parameter. In this case, the second parameter is the changeable range of the movement amount of projection C1 when projection C1 is translated.

For example, it is assumed that transition to the state “x4” is made by selection of the action “y12-” in the state “x3”. In this case, since the recognition rate of learned model M1 is improved, second evaluator 2 gives a reward of “+α” to the transition from the state “x3” to the state “x4”. Second evaluator 2 updates the Q factor in the cell in which the row of the state “x3” and the column of the action “y12-” intersect with each other with reference to the reward or the like described above.

Updating part 3 updates a parameter of data extension processing on the basis of the evaluation obtained by second evaluator 2. In other words, updating part 3 is an execution subject of update step ST3 of updating a parameter on the basis of the evaluation obtained by second evaluator 2 (second evaluation step ST2). That is, the evaluation method for learning data D1 according to the present exemplary embodiment further includes update step ST3. In the present exemplary embodiment, updating part 3 updates a parameter of data extension processing by selecting an action according to a predetermined algorithm in the Q table. In the initial state of the Q-table, updating part 3 randomly selects an arbitrary action from a plurality of actions. Thereafter, updating part 3 selects one action from a plurality of actions according to the ε-greedy method as an example. That is, updating part 3 generates a random number between 0 to 1 when selecting an action, randomly selects an action if the generated random number is equal to or less than “ε”, and selects an action with a larger Q factor if the generated random number is larger than “ε”. As a result, there is an advantage that learning of an appropriate Q factor for various actions easily proceeds without depending on the initial value of the Q factor.

### Operation

An example of the operation of model generation system 100 (including evaluation system 10) according to the present exemplary embodiment will be described below with reference to FIG. 7. Assume as a premise that data generator 4 has prepared a sufficient number of learning data D1 for machine learning of a model by executing data extension processing on the basis of the original learning data. Assume that model generator 5 generates learned model M1 in advance using prepared learning data D1. Assume also that in the Q table referred to by second evaluator 2, the initial state is “x1”.

First, first evaluator 1 evaluates the performance of learned model M1 (S1). Process S1 corresponds to first evaluation step ST1. More specifically, first evaluator 1 inputs the plurality of pieces of evaluation data D2 to learned model M1 to obtain the recognition rate of learned model M1 for the plurality of pieces of evaluation data D2.

In this case, if the recognition rate of learned model M1 has not reached the target (100% in this case) (S2: No), second evaluator 2 evaluates the parameters of data extension processing on the basis of the evaluation of the performance of learned model M1 by first evaluator 1 (S3). Process S3 corresponds to second evaluation step ST2. More specifically, second evaluator 2 updates the Q factor of the corresponding cell in the Q table stored in storage 6.

On the other hand, if the recognition rate of learned model M1 has reached the target (S2: Yes), model generation system 100 (that is, evaluation system 10) stops the operation. In other words, the machine learning of the model is completed. That is, when the evaluation obtained by first evaluator 1 reaches the target (giving correct answers to all pieces of the evaluation data), evaluation system 10 stops the operation, in other words, stops first evaluator 1 and second evaluator 2. As described above, in the evaluation method for learning data D1 according to the present exemplary embodiment, when the evaluation obtained in first evaluation step ST1 reaches the target, first evaluation step ST1 and second evaluation step ST2 are stopped.

In a case where process S3 has been performed, updating part 3 updates the parameter (of the data extension processing) on the basis of the evaluation of the parameter of the data extension processing by second evaluator 2 (S4). Process S4 corresponds to update step ST3. More specifically, updating part 3 updates the parameter by selecting an action according to a predetermined algorithm in the Q table.

Data generator 4 generates learning data D1 by data extension processing based on the parameters updated by updating part 3 (S5). Process S5 corresponds to data generation step ST4 described later. Model generator 5 generates learned model M1 by performing machine learning using learning data D1 generated by data generator 4 (S6). Process S6 corresponds to model generation step ST5 described later.

Subsequently, processes S1 to S6 are repeated until the recognition rate of learned model M1 reaches the target in process S2.

### Advantages

As described above, in the present exemplary embodiment, learned model M1 is evaluated, and the parameters of the data extension processing are evaluated on the basis of the evaluation. Therefore, in the present exemplary embodiment, it is possible to indirectly evaluate whether or not learning data D1 generated by the data extension processing is appropriate data for the generation of learned model M1. As a result, in the present exemplary embodiment, there is an advantage that it is easy to generate learning data D1 that can contribute to the improvement of the model recognition rate by updating the parameters of the subsequent data extension processing based on the evaluation of the parameters of the data extension processing.

That is, in the present exemplary embodiment, it is possible to search for an optimum parameter of data extension processing by repeating trial and error using the computer system. In the present exemplary embodiment, it becomes easy to generate learning data D1 that can contribute to the improvement of the recognition rate of the learned model on the basis of the parameter obtained by the search. As a result, in the present exemplary embodiment, it is easy to generate learned model M1 having a desired recognition rate by executing machine learning of the model using generated learning data D1.

### Modifications

The above exemplary embodiment is merely one of various exemplary embodiments of the present disclosure. The above exemplary embodiment can be variously changed according to a design and the like as long as the object of the present disclosure can be achieved. In addition, functions similar to those of evaluation system 10 for learning data D1 according to the above exemplary embodiment may be embodied by a computer program, a non-transitory recording medium recording a computer program, or the like other than the evaluation method for learning data D1. A (computer) program according to an aspect causes one or more processors to execute the above evaluation method for learning data D1.

In addition, functions similar to those of model generation system 100 according to the above exemplary embodiment may be embodied by a generation method for learned model M1, a computer program, a non-transitory recording medium recording a computer program, or the like. Furthermore, a function similar to the configuration for generating learning data D1 in model generation system 100 according to the above exemplary embodiment may be embodied by a generation method for learning data D1, a computer program, a non-transitory recording medium recording the computer program, or the like.

A generation method for learning data D1 according to one aspect includes first evaluation step ST1, second evaluation step ST2, update step ST3, and data generation step ST4. First evaluation step ST1 is a step of evaluating the performance of learned model M1 machine-learned by using learning data D1 generated by the data extension processing. Second evaluation step ST2 is a step of evaluating the parameter on the basis of the evaluation in first evaluation step ST1 and the possible range of the parameter of the data extension processing. Update step ST3 is a step of updating a parameter on the basis of the evaluation obtained in second evaluation step ST2. Data generation step ST4 is a step of generating learning data D1 by data extension processing based on the parameter updated in update step ST3. In the above exemplary embodiment, the execution subject of data generation step ST4 is data generator 4.

A generation method for learned model M1 according to one aspect includes first evaluation step ST1, second evaluation step ST2, update step ST3, data generation step ST4, and model generation step ST5. First evaluation step ST1 is a step of evaluating the performance of learned model M1 machine-learned by using learning data D1 generated by the data extension processing. Second evaluation step ST2 is a step of evaluating the parameter on the basis of the evaluation in first evaluation step ST1 and the possible range of the parameter of the data extension processing. Update step ST3 is a step of updating a parameter on the basis of the evaluation obtained in second evaluation step ST2. Data generation step ST4 is a step of generating learning data D1 by data extension processing based on the parameter updated in update step ST3. Model generation step ST5 is a step of generating learned model M1 by performing machine learning using learning data D1 generated in data generation step ST4. In the above exemplary embodiment, the execution subject of model generation step ST5 is model generator 5.

Modifications of the exemplary embodiment described above will be listed below. The modifications described below can be applied in appropriate combination.

Model generation system 100 according to the present disclosure includes, for example, a computer system in first evaluator 1, second evaluator 2, updating part 3, data generator 4, model generator 5, and the like. The computer system mainly includes a processor and a memory as hardware. By the processor executing a program recorded in the memory of the computer system, a function as model generation system 100 according to the present disclosure is implemented. The program may be recorded in advance in the memory of the computer system, may be provided through a telecommunication line, or may be provided by being recorded in a non-transitory recording medium readable by the computer system, such as a memory card, an optical disk, or a hard disk drive. The processor of the computer system includes one or a plurality of electronic circuits including a semiconductor integrated circuit (IC) or a large-scale integration (LSI). The integrated circuit such as the IC or the LSI in this disclosure is called differently depending on a degree of integration, and includes an integrated circuit called a system LSI, a very large scale integration (VLSI), or an ultra large scale integration (ULSI). Furthermore, a field programmable gate array (FPGA) programmed after manufacture of an LSI, and a logical device capable of reconfiguring a joint relationship inside an LSI or reconfiguring circuit partitions inside the LSI can also be used as processors. The plurality of electronic circuits may be integrated into one chip or may be provided in a distributed manner on a plurality of chips. The plurality of chips may be aggregated in one device or may be provided in a distributed manner in a plurality of devices. The computer system in this disclosure includes a microcontroller having one or more processors and one or more memories. Therefore, the microcontroller is also constituted by one or a plurality of electronic circuits including a semiconductor integrated circuit or a large-scale integrated circuit.

In addition, it is not an essential configuration for model generation system 100 that a plurality of functions in model generation system 100 are aggregated in one housing, and the components of model generation system 100 may be provided in a distributed manner in a plurality of housings. Furthermore, at least a part of the functions of model generation system 100 may be achieved by a cloud (cloud computing) or the like.

In the above exemplary embodiment, evaluation system 10 may be configured to stop the operation when the evaluation obtained by first evaluator 1 converges to a predetermined value even if the evaluation obtained by first evaluator 1 does not reach the target, in other words, may be configured to stop first evaluator 1 and second evaluator 2. In other words, in the evaluation method for learning data D1 according to the present exemplary embodiment, when the evaluation obtained in first evaluation step ST1 reaches a predetermined value, first evaluation step ST1 and second evaluation step ST2 may be stopped.

In the above exemplary embodiment, first evaluator 1 evaluates the recognition rate when all pieces of evaluation data D2 are input to learned model M1 as the performance of learned model M1. However, the present invention is not limited to this. For example, first evaluator 1 may evaluate the performance of learned model M1 for each of the plurality of pieces of evaluation data D2 input to learned model M1. In other words, in evaluation method for learning data D1 according to the present exemplary embodiment, first evaluation step ST1 may evaluate the performance of learned model M1 for each of the plurality of pieces of evaluation data D2 input to learned model M1.

In this aspect, second evaluator 2 evaluates a parameter of data extension processing by updating the state action value (Q factor) of each cell (field) of the Q table illustrated in following Table 2 stored in storage 6. In the example illustrated in Table 2, the Q factors of all the cells in the Q table are initial values (zero). Assume that in this case, for the sake of simplicity, the plurality of pieces of evaluation data D2 include only two pieces of data, namely, the first evaluation data and the second evaluation data.

Table 2

| | y11+ | y11- | y12+ | y12- | y21+ | y21- | y22+ | y22- |
|---|---|---|---|---|---|---|---|---|
| x10, x20 | 0 | 0 | 0 | 0 | 0 | 0 | 0 | 0 |
| x10, x21 | 0 | 0 | 0 | 0 | 0 | 0 | 0 | 0 |
| x11, x20 | 0 | 0 | 0 | 0 | 0 | 0 | 0 | 0 |
| x11, x21 | 0 | 0 | 0 | 0 | 0 | 0 | 0 | 0 |

In the example illustrated in Table 2, “x10, x20”, “x10, x21”, “x11, x20”, and “x11, x21” represent states, respectively. Note that “x10” indicates that the recognition of learned model M1 with respect to the first evaluation data is correct, and “x11” indicates that the recognition of learned model M1 with respect to the first evaluation data is incorrect. Note also that “x20” indicates that the recognition of learned model M1 with respect to the second evaluation data is correct, and “x21” indicates that the recognition of learned model M1 with respect to the second evaluation data is incorrect. That is, in this aspect, when the number of the plurality of pieces of evaluation data D2 is “n (n is a natural number)”, the number of states in the Q table is “2ⁿ”.

In this aspect, since the performance of learned model M1 is evaluated for each of the plurality of pieces of evaluation data D2, there is an advantage that it is further easy to generate learning data D1 that can contribute to the improvement of the model recognition rate as compared with the above exemplary embodiment.

In the above exemplary embodiment, second evaluator 2 may evaluate a parameter of data extension processing on the basis of the preprocessing parameter related to the preprocessing. The preprocessing is processing executed on learning data D1 (image data in this case) in the process of performing machine learning using learning data D1. For example, the preprocessing includes smoothing processing such as removal of white noise. In other words, in the evaluation method for learning data D1 according to the present exemplary embodiment, second evaluation step ST2 may evaluate a parameter (of data extension processing) on the basis of a preprocessing parameter.

For example, in a case where the processing of adding white noise to image data is included in data extension processing, if the white noise is removed in the preprocessing, the data extension processing may be invalidated. In such a case, if the parameter of the data extension processing is evaluated on the basis of the preprocessing parameter as described above, there is an advantage that an action of adding white noise in the data extension processing is not selected, and invalidation of the data extension processing is easily avoided.

In the above exemplary embodiment, although the Q table illustrated as an example in Table 1 includes five states (“x1” to “x5”), the table may include less than five states or may include more states. In the example illustrated in Table 1, the number of types of parameters of the data extension processing is two (the first parameter and the second parameter) or may be one or more.

In the above exemplary embodiment, second evaluator 2 evaluates the parameter of the data extension processing by updating the Q factor of each cell in the Q table. However, the present invention is not limited to this. For example, second evaluator 2 may evaluate the parameter of the data extension processing by updating the state value function or the state action value function instead of the Q table. In this case, the state value function is a function that defines the value of being in a certain state. In addition, the state action value function is a function that defines a value of selecting a certain action in a certain state. Furthermore, for example, second evaluator 2 may evaluate the parameter of the data extension processing by using a deep Q network (DQN) instead of the Q table. These aspects are effective when the number of combinations of the type of states and the types of actions is enormous.

In the above exemplary embodiment, first evaluator 1 may evaluate the performance of learned model M1 by loss instead of the recognition rate. The “loss” in the present disclosure refers to the degree of deviation between the label of evaluation data D2 and the estimation result of learned model M1 when evaluation data D2 is input to learned model M1. For example, it is assumed that when evaluation data D2 including the image data of bead B1 having spatter B4 is input to learned model M1, learned model M1 outputs an estimation result indicating that bead B1 has spatter B4 with a probability of 80%. In this case, first evaluator 1 evaluates that the loss of learned model M1 with respect to evaluation data D2 is 20% (= 100% - 80%). In this aspect, updating part 3 may update the parameter of data extension processing so as to minimize the loss of learned model M1.

In the above exemplary embodiment, model generation system 100 discards learned model M1 before update and newly generates learned model M1 every time updating part 3 updates a parameter of data extension processing. However, in this aspect, the time required to complete machine learning tends to be long.

Accordingly, every time updating part 3 updates a parameter of data extension processing, model generation system 100 may store pre-update learned model M1 in storage 6 and train pre-update learned model M1. In this aspect, when the recognition rate of learned model M1 decreases in first evaluator 1, learned model M1 may be discarded, and relearning may be performed using learned model M1 stored in storage 6. This aspect has an advantage that it is easy to shorten the time required to complete machine learning as compared with a case where learned model M1 is separately newly generated every time a parameter of data extension processing is updated.

In the above exemplary embodiment, learning data D1 is generated by adding additional image D11 representing the characteristic of a defective product to the image data of non-defective bead B1.However, the present invention is not limited to this. For example, learning data D1 may be generated by changing a portion representing the characteristic of a defective product with respect to the image data of defective bead B1. In addition, learning data D1 may be generated by removing a portion representing the characteristic of a defective product from the image data of defective bead B1.

According to the above exemplary embodiment, learned model M1 is used for welding appearance inspection for inspecting whether or not bead B1 is a non-defective product, in other words, whether or not welding has been correctly performed. However, the present invention is not limited to this. That is, evaluation system 10 may use learned model M1 for any purpose as long as it can evaluate the parameters of data extension processing.

In the above exemplary embodiment, first evaluator 1 evaluates the recognition rate when all pieces of evaluation data D2 are input to learned model M1 as the performance of learned model M1. However, the present invention is not limited to this. This point will be described in detail below.

As in the above exemplary embodiment, data extension processing is performed in a case where the number of pieces of evaluation data D2 is small, and in most cases, only a small number of pieces of evaluation data D2 can be collected in the first place. In this case, even if a parameter of data extension processing is slightly changed, the recognition rate of learned model M1 does not change or only slightly changes if any. For this reason, no matter how the upper limit value or the lower limit value of a parameter is changed, the evaluation obtained by second evaluator 2 does not change or only slightly changes if any. This makes it difficult to proceed with learning such as reinforcement learning.

Accordingly, in the above exemplary embodiment, when the recognition rate of learned model M1 remains the same (or similar), second evaluator 2 may perform evaluation such that the wider the possible range of a parameter, the higher the evaluation. More specifically, second evaluator 2 performs evaluation based on the recognition rate of learned model M1 and the diversity degree (in other words, the diversity degree of parameters) of the data generated by data extension processing. That is, the evaluation obtained by second evaluator 2 is expressed by equation (1) given below. In equation (1), “E1” represents the evaluation obtained by second evaluator 2, “R1” represents the recognition rate of learned model M1, and “PD₁, PD₂,..., PDₙ” (“n” is a natural number) represent the diversity degree of each parameter. Furthermore, in equation (1), “γ₁, γ₂,..., γₙ” are correlation coefficients between the recognition rate of learned model M1 and the diversity degree of the parameter and can take a value of 0.01 ~ 0.001 as an example.

$$E 1 = R 1 + {γ}_{1} P {D}_{1} + {γ}_{2} P {D}_{2} + ⋯ {γ}_{n} P {D}_{n}$$

In this case, for example, it is assumed that the k-th parameter (“k” is a natural number equal to or less than “n”) is a value indicating a magnification ratio when data extension processing is performed, and an upper limit value and a lower limit value of the k-th parameter are “Pk_max” and “Pk_min”, respectively. In this case, diversity degree PDₖ of the k-th parameter is expressed by the expression “PDₖ = Pₖ_max/Pₖ_min”. Note that, also in a case where the k-th parameter is a value indicating the size of a grain added as noise when the data extension process is performed, and the upper limit value and the lower limit value of the k-th parameter are “Pk_max” and “Pk min”, respectively, diversity degree PDₖ of this parameter can be expressed by the above equation. In this case, for example, it is assumed that the k-th parameter (“k” is a natural number equal to or less than “n”) is a value indicating a magnification ratio when data extension processing is performed, and the variance of the k-th parameter is “σ”. In this case, diversity degree PDₖ of the k-th parameter is expressed by the expression “PDₖ = σ”. The variance is an example and may be a statistical value indicating diversity of other distributions.

In addition, for example, it is assumed that the k-th parameter is a value indicating a rotation angle when data extension processing is performed, and an upper limit value and a lower limit value of the k-th parameter are “Pk_max” and “Pk_min”, respectively. In this case, diversity degree PDₖ of the k-th parameter is expressed by the expression “PDₖ = |Pₖ_max - Pₖ_min|”. Note that, also in a case where the k-th parameter is a value indicating the shift amount of translation when the data extension process is performed, and the upper limit value and the lower limit value of the k-th parameter are “Pk_max” and “Pk_min”, respectively, diversity degree PDₖ of this parameter can be expressed by the above equation.

Furthermore, in a case where learning is performed by reinforcement learning, a positive reward is set when the diversity degree of a parameter increases, and a negative reward is set when the diversity degree of the parameter decreases. For example, the reward when the recognition rate of learned model M1 increases is set to +1, the reward when the recognition rate decreases is set to -1, the reward when the recognition rate does not change but the diversity degree of the parameter increases is set to +0.2, and the reward when the recognition rate does not change but the diversity degree of the parameter decreases is set to -0.2.

As described above, second evaluator 2 may evaluate the parameters of data extension processing on the basis of the recognition rate of learned model M1 and the diversity degree (in other words, the diversity degree of the parameters) of the data generated by the data extension processing. In this aspect, there is an advantage that parameters can be easily optimized even when the number of pieces of evaluation data D2 is small. In particular, since it is evaluated that learning data D1 that is not similar to evaluation data D2 is generated by increasing the parameter evaluation as the parameter diversity degree is higher and decreasing the parameter evaluation as the parameter diversity degree is lower, there is an advantage that learned model M1 with high generalization performance is easily generated.

### Conclusion

As described above, the evaluation method for learning data according to the first aspect includes first evaluation step (ST1) and second evaluation step (ST2). First evaluation step (ST1) is a step of evaluating the performance of learned model (M1) machine-learned by using learning data (D1) generated by the data extension processing. Second evaluation step (ST2) is a step of evaluating the parameter (of the data extension processing) on the basis of the evaluation in first evaluation step (ST1) and the possible range of the parameter of the data extension processing.

According to this aspect, there is an advantage that it is easy to generate learning data (D1) that can contribute to the improvement of a model recognition rate.

In the evaluation method for learning data according to the second aspect, in the first aspect, the evaluation obtained in second evaluation step (ST2) is higher as the performance in first evaluation step (ST1) is higher. The evaluation obtained in second evaluation step (ST2) is higher as the possible range of the parameter is wider.

According to this aspect, there is an advantage that it is easy to optimize a parameter even when the number of pieces of evaluation data (D2) input to learned model (M1) is small.

The evaluation method for learning data according to the third aspect further includes update step (ST3), a storage step, and a comparison step in the first or second aspect. Update step (ST3) is a step of updating a parameter on the basis of the evaluation obtained in second evaluation step (ST2). The storage step is a step of storing learned model (M1) before update step (ST3) is executed. The comparison step is a step of comparing learned model (M1) after the execution of update step (ST3) with learned model (M1) stored in the storage step.

This aspect has an advantage that it is easy to shorten the time required to complete machine learning as compared with a case where learned model (M1) is separately newly generated every time a parameter of data extension processing is updated.

In the evaluation method for learning data according to the fourth aspect, in any one of the first to third aspects, learning data (D1) is generated by adding additional image (D11) based on the parameters to image data (D10) including the recognition target of learned model (M1).

According to this aspect, there is an advantage that the machine learning of a model can be performed using the type of learning data (D1) that does not exist in existing learning data (D1).

In the evaluation method for learning data according to the fifth aspect, in any one of the first to fourth aspects, when the evaluation obtained in first evaluation step (ST1) reaches the target, first evaluation step (ST1) and second evaluation step (ST2) are stopped.

According to this aspect, there is an advantage that it is easy to prevent over-learning caused by continuing learning even when the performance of learned model (M1) reaches the target.

In the evaluation method for learning data according to the sixth aspect, in any one of the first to fourth aspects, when the evaluation obtained in first evaluation step (ST1) converges to a predetermined value, first evaluation step (ST1) and second evaluation step (ST2) are stopped.

According to this aspect, there is an advantage that it is easy to prevent over-learning caused by continuing learning even when the performance of learned model (M1) is saturated.

In the evaluation method for learning data according to the seventh aspect, in any one of the first to sixth aspects, first evaluation step (ST1) evaluates the performance of learned model (M1) for each of the plurality of pieces of evaluation data (D2) input to learned model (M1).

According to this aspect, there is an advantage that it is further easy to generate learning data (D1) that can contribute to the improvement of a model recognition rate.

In the evaluation method for learning data according to the eighth aspect, in any one of the first to seventh aspects, second evaluation step (ST2) evaluates a parameter on the basis of a preprocessing parameter related to preprocessing. The preprocessing is processing executed on learning data (D1) in the process of performing machine learning using learning data (D1).

According to this aspect, there is an advantage that invalidation of data extension processing by preprocessing can be easily avoided.

The program according to the ninth aspect causes one or more processors to execute the evaluation method for learning data according to any one of the first to eighth aspects.

According to this aspect, there is an advantage that it is easy to generate learning data (D1) that can contribute to the improvement of a model recognition rate.

The generation method for learning data according to the 10th aspect includes first evaluation step (ST1), second evaluation step (ST2), update step (ST3), and data generation step (ST4). First evaluation step (ST1) is a step of evaluating the performance of learned model (M1) machine-learned by using learning data (D1) generated by the data extension processing. Second evaluation step (ST2) is a step of evaluating the parameter (of the data extension processing) on the basis of the evaluation in first evaluation step (ST1) and the possible range of the parameter of the data extension processing. Update step (ST3) is a step of updating a parameter on the basis of the evaluation obtained in second evaluation step (ST2). Data generation step (ST4) is a step of generating learning data (D1) by data extension processing based on the parameter updated in update step (ST3).

According to this aspect, there is an advantage that it is easy to generate learning data (D1) that can contribute to the improvement of a model recognition rate.

The generation method for a learned model according to the 11th aspect includes first evaluation step (ST1), second evaluation step (ST2), update step (ST3), data generation step (ST4), and model generation step (ST5). First evaluation step (ST1) is a step of evaluating the performance of learned model (M1) machine-learned by using learning data (D1) generated by the data extension processing. Second evaluation step (ST2) is a step of evaluating the parameter (of the data extension processing) on the basis of the evaluation in first evaluation step (ST1) and the possible range of the parameter of the data extension processing. Update step (ST3) is a step of updating a parameter on the basis of the evaluation obtained in second evaluation step (ST2). Data generation step (ST4) is a step of generating learning data (D1) by data extension processing based on the parameter updated in update step (ST3). Model generation step (ST5) is a step of generating learned model (M1) by performing machine learning using learning data (D1) generated in data generation step (ST4).

According to this aspect, there is an advantage that learned model (M1) having a desired recognition rate is easily generated.

Evaluation system (10) for learning data according to the 12th aspect includes first evaluator (1) and second evaluator (2). First evaluator (1) evaluates the performance of learned model (M1) machine-learned by using learning data (D1) generated by the data extension processing. Second evaluator (2) evaluates the parameter on the basis of the evaluation obtained by first evaluator (1) and the possible range of the parameter of the data extension processing.

According to this aspect, there is an advantage that it is easy to generate learning data (D1) that can contribute to the improvement of a model recognition rate.

The methods according to the second to eighth aspects are not essential to the evaluation method for learning data and can be omitted as appropriate.

### Industrial Applicability

The evaluation method for learning data, the program, the generation method for learning data, the generation method for a learned model, and the evaluation system for learning data according to the present disclosure have an advantage of easily generating learning data that can contribute to the improvement of the model recognition rate. Accordingly, the invention according to the present disclosure contributes to the improvement of efficiency of defective product analysis and the like and is industrially useful.

### REFERENCE MARKS IN THE DRAWINGS

10 evaluation system
1 first evaluator
2 second evaluator
ST1 first evaluation step
ST2 second evaluation step
ST3 update step
ST4 data generation step
ST5 model generation step
D1 learning data
D11 additional image
D2 evaluation data
M1 learned model

1. An evaluation method for learning data, the method comprising:
a first evaluation step of evaluating performance of a learned model machine-learned by using learning data generated by data extension processing; and
a second evaluation step of evaluating a parameter of the data extension processing based on evaluation obtained in the first evaluation step and a possible range of the parameter.

2. The evaluation method for learning data according to claim 1, wherein
the evaluation obtained in the second evaluation step is higher as the evaluation of performance in the first evaluation step is higher, and
the evaluation obtained in the second evaluation step is higher as the possible range of the parameter is wider.

3. The evaluation method for learning data according to claim 1, further comprising:
an update step of updating the parameter based on the evaluation obtained in the second evaluation step;
a storage step of storing the learned model before execution of the update step; and
a comparison step of comparing the learned model after execution of the update step with the learned model stored in the storage step.

4. The evaluation method for learning data according to claim 1, wherein the learning data is generated by adding an additional image based on the parameter to image data including a recognition target of the learned model.

5. The evaluation method for learning data according to claim 1, wherein when the evaluation obtained in the first evaluation step reaches a target, the first evaluation step and the second evaluation step are stopped.

6. The evaluation method for learning data according to claim 1, wherein when the evaluation obtained in the first evaluation step converges to a predetermined value, the first evaluation step and the second evaluation step are stopped.

7. The evaluation method for learning data according to claim 1, wherein the first evaluation step evaluates performance of the learned model for each of a plurality of pieces of evaluation data input to the learned model.

8. The evaluation method for learning data according to claim 1, wherein the second evaluation step evaluates the parameter based on a preprocessing parameter related to preprocessing executed on the learning data in a process of performing machine learning using the learning data.

9. (canceled)

10. A generation method for learning data, the method comprising:
a first evaluation step of evaluating performance of a learned model machine-learned by using learning data generated by data extension processing;
a second evaluation step of evaluating a parameter of the data extension processing based on evaluation obtained in the first evaluation step and a possible range of the parameter;
an update step of updating the parameter based on evaluation obtained in the second evaluation step; and
a data generation step of generating the learning data by the data extension processing based on the parameter updated in the update step.

11. A generation method for a learned model, the method comprising:
a first evaluation step of evaluating performance of a learned model machine-learned by using learning data generated by data extension processing;
a second evaluation step of evaluating a parameter of the data extension processing based on evaluation obtained in the first evaluation step and a possible range of the parameter;
an update step of updating the parameter based on evaluation obtained in the second evaluation step;
a data generation step of generating the learning data by the data extension processing based on the parameter updated in the update step; and
a model generation step of generating the learned model by performing machine-learning using the learning data generated in the data generation step.

12. An evaluation system for learning data, the system comprising:
a first evaluator configured to evaluate performance of a learned model machine-learned by using learning data generated by data extension processing; and
a second evaluator configured to evaluate a parameter of the data extension processing based on evaluation obtained by the first evaluator and a possible range of the parameter.

13. An evaluation method for learning data, the method comprising:
a first evaluation step of evaluating a similarity between learning data and evaluation data; and
a second evaluation step of evaluating a parameter based on evaluation obtained in the first evaluation step and a possible range of the parameter of data extension processing.

14. The evaluation method for learning data according to claim 13, wherein the similarity is a cumulative total of similarity of each piece of learning data most similar to an element included in the evaluation data.
